(19) United States
(12) Patent Application Publication
(10) Pub. No.: US 2017/0131954 A1
(43) Pub. Date: May 11, 2017

(54) Managing Printing to Reduce Physical Media Waste

(71) Applicant: International Business Machines Corporation, Armonk, NY (US)

(72) Inventors: Heidi Lagares-Greenblatt, Jefferson Hills, PA (US); Jenny S. Li, Danbury, CT (US); Xinlin Wang, Irvine, CA (US)

(21) Appl. No.: 14/934,489

(22) Filed: Nov. 6, 2015

(51) Int. Cl. G06F 3/12

(52) U.S. Cl. CPC G06F 3/1219; G06F 3/1239; G06F 3/125; G06F 3/1267; G06F 3/1287

(57) ABSTRACT

One or more information for printing associated with one or more users is determined. One or more printers having one or more physical media associated with the one or more printers is determined. A first indication is received from a user of the one or more users to print the one or more information associated with the user. An order of the one or more information to be printed on the one or more physical media is determined. The order minimizes the usage of space on the one or more physical media.

### BACKGROUND

The present invention relates generally to the field of printing devices, and more particularly to managing printing to reduce physical media waste.

In computing, a printer is a peripheral which makes persistent human readable representation of graphics or text on paper or similar physical media. The two most common printer mechanisms are black and white laser printers used for common documents, and color inkjet printers which can produce high quality photograph quality output. Personal printers are primarily designed to support individual users, are generally designed for low-volume, short-turnaround print jobs, and may be connected to only a single computer or device. Networked or shared printers are primarily designed to support large numbers of people, are generally designed for high-volume, high-speed printing and may be connected to multiple computers or devices.

### SUMMARY OF THE INVENTION

Embodiments of the present invention include a method, computer program product, and system for managing printing to reduce physical media waste. In one embodiment, one or more information for printing associated with one or more users is determined. One or more printers having one or more physical media associated with the one or more printers is determined. A first indication is received from a user of the one or more users to print the one or more information associated with the user. An order of the one or more information to be printed on the one or more physical media is determined. The order minimizes the usage of space on the one or more physical media.

### BRIEF DESCRIPTION OF THE DRAWINGS

FIG. 1 depicts a cloud computing environment according to an embodiment of the present invention;

FIG. 2 depicts abstraction model layers according to an embodiment of the present invention;

FIG. 3 depicts a functional block diagram of a data processing environment, in accordance with an embodiment of the present invention;

FIG. 4 depicts a flowchart of operational steps of a program for managing printing to reduce physical media waste, in accordance with an embodiment of the present invention;

FIGS. 5A-5I depict examples of information to be printed or printed information, in accordance with embodiments of the present invention; and

FIG. 6 depicts a block diagram of components of the computer of FIG. 3, in accordance with an embodiment of the present invention.

### DETAILED DESCRIPTION OF THE PREFERRED EMBODIMENTS

Embodiments of the present invention provide for managing printing to reduce physical media waste. Embodiments of the present invention provide for determining one or more printers that are to be used for printing and the printing material that can be printed by the one or more printers. Embodiments of the present invention provide for receiving information for printing from any numbers of users and from any numbers of devices and from any number of applications found on the any number of devices. Embodiments of the present invention provide for storing the information receive for printing in a printing buffer associated with the user that wants to print the information. Embodiments of the present invention allow for a default printing manner in the order the information to print that was received in the printing buffer from the user. Embodiments of the present invention allow for determining an order of printing the information to print that was received in the printing buffer. Embodiments of the present invention allow for determining the order using information about the physical media that the information to be printed will be printed on to reduce the use of physical media. Embodiments of the present invention allow for printing on physical media that has already been printed on. Embodiments of the present invention allow for modification of the determined order.

Embodiments of the present invention recognize that large amounts of documents are printed every day which leads to large amounts of paper being used. Embodiments of the present invention recognize that the large amount of paper being used may lead to large amounts of wasted paper that does not have information printed (i.e. white space). Embodiments of the present invention recognize that when small documents (i.e. documents that do not take up a whole page of a paper) are printed there is large amounts of wasted white space.

The present invention will now be described in detail with reference to the Figures.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

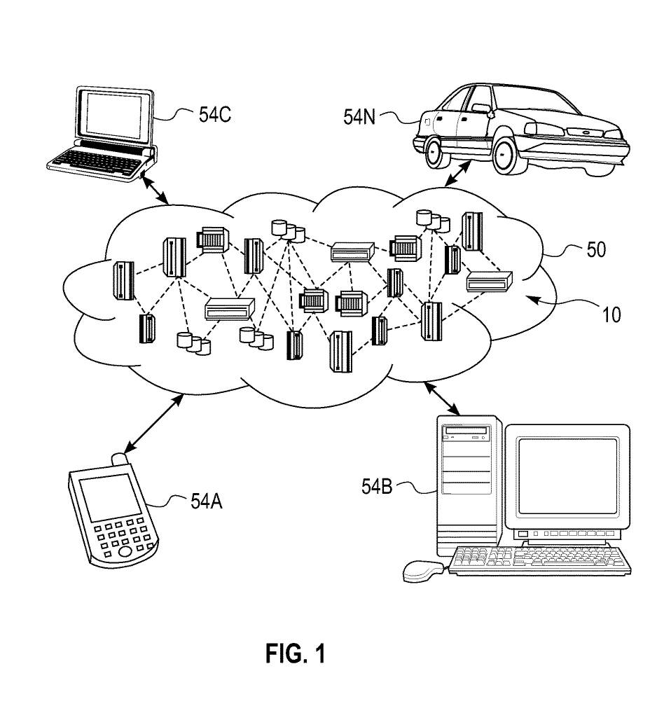

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

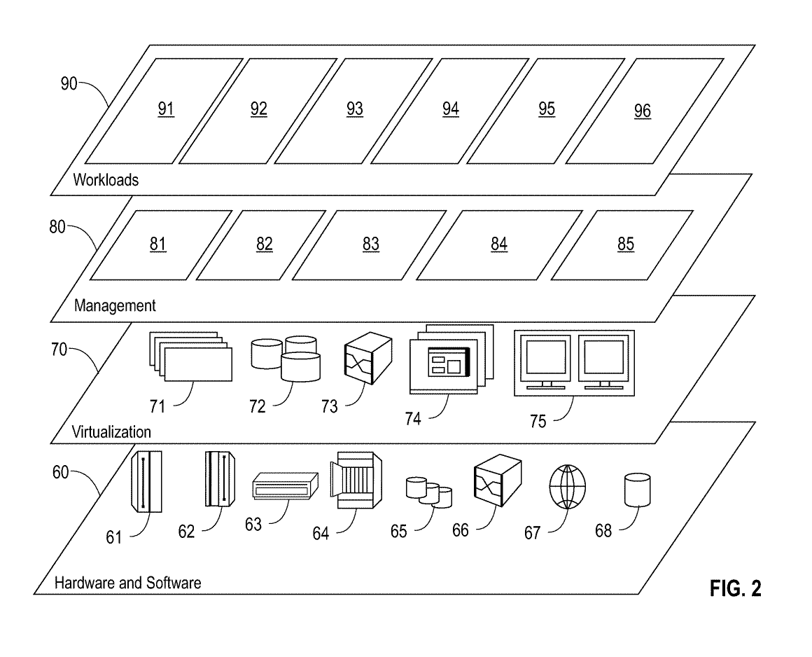

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and printing optimization 96.

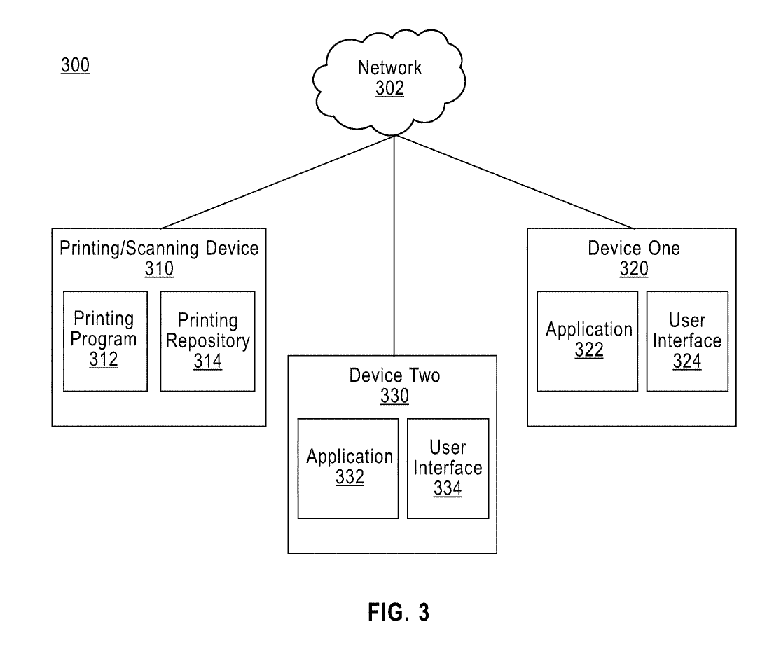

FIG. 3 is a functional block diagram illustrating a data processing environment, generally designated 300, in accordance with one embodiment of the present invention. FIG. 3 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

An embodiment of data processing environment 300 includes printing/scanning device 310, device one 320 and device two 330 interconnected over network 302. Network 302 can be, for example, a local area network (LAN), a telecommunications network, a wide area network (WAN) such as the Internet, or any combination of the three, and include wired, wireless, or fiber optic connections. In general, network 302 can be any combination of connections and protocols that will support communications between printing/scanning device 310, device one 320, device two 330 and any other computer connected to network 302, in accordance with embodiments of the present invention.

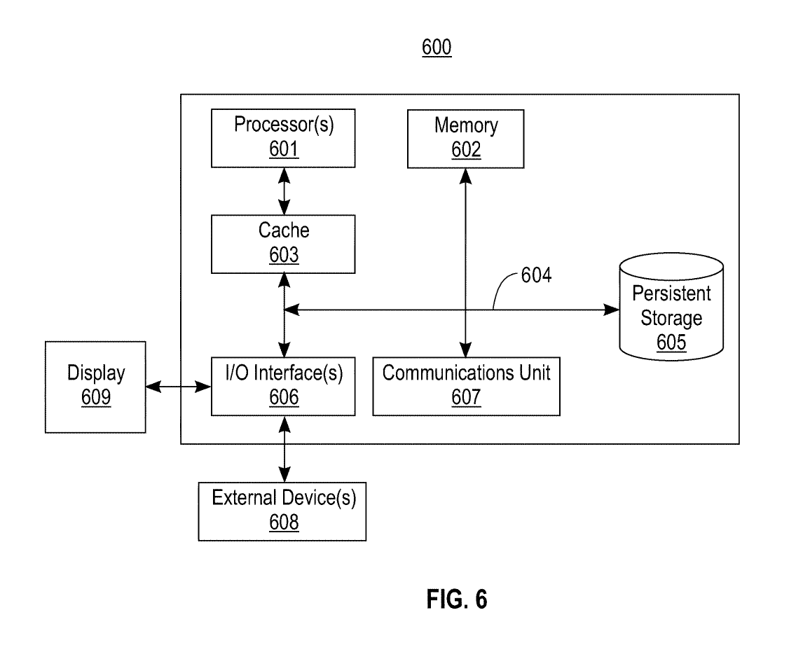

In an embodiment, printing/scanning device 310 may be a device that makes a persistent human readable representation of graphics or text on physical media. For example, printing/scanning device 310 may be a laser printer that has the ability to print in black and white or an inkjet printer that has the ability to print in color but any other form of printer may be realized. In an embodiment, physical media may be any form of physical media that can have a persistent human readable representation printed onto the physical media. For example, this may be paper (e.g., white paper, colored paper, etc.), recycled paper, paper that has persistent human readable representations of graphics or text already on the paper, plastic, carbon paper, transparencies, etc. In an embodiment, the physical media may be any physical media that can be used in 3D (three-dimensional) printing (i.e., polymide, ABS (Acylonitrile Butadiene Styrene), PLA (Poly Lactic Acid), wax, etc.). In an embodiment, any of the physical media may have persistent human readable representations of graphics or text already on the physical media. In an embodiment, printing/scanning device 310 may have multiple trays or compartments that hold the same or different physical media and allow for printing on a single form of physical media or multiple forms of physical media for the same printing job. In an embodiment, printing/scanning device 310 may include a scanning device that can scan physical media and convert the scanned physical media to a digital image. In an embodiment, printing/scanning device 310 may scan physical media to determine what persistent human readable representations of graphics or text already exist on physical media. Printing/scanning device 310 may be capable of communicating with any computing device within data processing environment 300. In general, printing/scanning device 310 may be capable of executing computer readable program instructions. In an embodiment, printing/scanning device 310 may be a 3D printer. Printing/scanning device 310 may include components as depicted and described in detail with respect to computer system 600, as described in reference to FIG. 6, in accordance with embodiments of the present invention. Printing/scanning device 310 can be a node that is part of cloud computing environment 50, as described in reference to FIG. 1.

In an embodiment, printing/scanning device 310 includes printing program 312 and printing repository 314. In an embodiment, printing program 312 is a program, application, or subprogram of a larger program that manages printing to reduce physical media waste. In an alternative embodiment, printing program 312 may be located on device one 320, device two 330, or any other device accessible by printing/scanning device 310 via network 302. In an embodiment, printing repository 314 may include a single printing buffer (i.e., a list of items transmitted to printing/scanning device 310 for printing) or multiple printing buffers and each of the multiple printing buffers is associated with a single user or a group of users. In an alternative embodiment, printing repository 314 may be located on device one 320, device two 330, or any other device accessible by printing/scanning device 310 via network 302.

In an embodiment, printing program 312 may determine one or more printers that are to be used for printing and the printing material that can be printed by the one or more printers. In an embodiment, printing program 312 may receive information for printing from users using any number of devices (e.g. device one 320, device two 330, etc.) and more specifically from applications found on those devices (e.g., application 322, application 332, etc.) In an embodiment, printing program 312 stores the information received for printing in printing repository 314 in a printing buffer for the user that submits the information to be printed. In an embodiment, printing program 312 receives an indication from a user to print the information stored in the buffer associated with the user. In an embodiment, printing program 312 receives an indication from a user not to green print (i.e., reduce physical media waste) and printing program 312 prints the information stored in the buffer associated with the user in a default printing manner. In an embodiment, printing program 312 receives an indication from a user to green print and printing program 312 determines the physical media that printing/scanning device 310 has available to use for printing. In an embodiment, printing program 312 provides an order that the information stored in the buffer associated with the user can be printed that manages printing to reduce physical media waste (i.e., green printing) and the user indicates that the order is correct or may modify the order and perform a manual printing. In an embodiment, printing program provides an order that the information stored in the buffer associated with the user can be printed on a 3-D printer so as to reduce the amount of physical media waste used by the 3-D printer.

In an embodiment, printing/scanning device 310 includes printing repository 314. In an embodiment, printing repository 314 may include one or multiple printing buffers. In an embodiment, the print buffer is a location in memory that holds data (i.e., information that is sent to printing/scanning device 310 for printing). In an embodiment, the print buffer holds the data in the order that it was received from the user until an indication to print is received, the printer is ready to respond, or both. In an embodiment, printing repository 314 may be managed by printing program 312. In an alternative embodiment, printing repository 314 may be managed by the operating system of the computer, alone, or together with, printing program 312. In other embodiments, the printing buffer may be similar to a print buffer or print spool. In an embodiment, printing repository 314 may include one printing buffer that is associate with a single user. In another embodiment, printing repository 314 may include one or more printing buffers that are each associated with a single unique user. In yet another embodiment, printing repository 314 may include one or more printing buffers that are each associated with one or more users and the one or more users may be unique or similar. For example, print buffer A may be associated with user A; print buffer B may be associated with user B, and print buffer C may be associated with user C. In another example, print buffer A may be associated with user A and user D; print buffer B may be associated with user B; and print buffer C may be associated with user C and user E. In even yet another example, print buffer A may be associated with user A and user D; print buffer B may be associated with user B and D; and print buffer C may be associated with user C and user E. In another example, print buffer A may be associated with all connected devices or computers owned by user A.

Printing repository 314 may be implemented using any volatile or non-volatile storage media for storing information, as known in the art. For example, printing repository 314 may be implemented with a tape library, optical library, one or more independent hard disk drives, multiple hard disk drives in a redundant array of independent disks (RAID), solid-state drives (SSD), or random-access memory (RAM). Similarly, printing repository 314 may be implemented with any suitable storage architecture known in the art, such as a relational database, an object-oriented database, or one or more tables. In an embodiment, the memory size of printing repository 314 may be modified (e.g., increased) if the printing buffer(s) found in printing repository 314 expand and printing repository 314 can be expanded using memories found on other devices connected to printing/scanning device 310, using implementation such a cloud services.

In an embodiment, device one 320 may be a laptop, tablet, or netbook personal computer (PC), a desktop computer, a personal digital assistant (PDA), a smart phone, camera, video camera, video device or any programmable electronic device capable of communicating with any computing device within data processing environment 300. In certain embodiments, device one 320 collectively represents a computer system utilizing clustered computers and components (e.g., database server computers, application server computers, etc.) that act as a single pool of seamless resources when accessed by elements of data processing environment 300, such as in a cloud computing environment, discussed previously. In general, device one 320 is representative of any electronic device or combination of electronic devices capable of executing computer readable program instructions. In an embodiment, device one 320 may include components as depicted and described in detail with respect to FIG. 6, in accordance with embodiments of the present invention. In an embodiment, device one 320 can be a node that is part of cloud computing environment 50. In an embodiment, device one 320 may be substantially similar to device two 330.

In an embodiment, device one 320 includes application 322 and user interface 324. In an embodiment, user interface 322 is program that allows a user of device one 320 to interact with application 322, with printing program 312 via network 302, or with any other device connected to device one 320 via network 302. In an embodiment, application 322 is a program or add-on to another program that a user may want to print information from (e.g., word processor, photo editor, electronic mail client, etc.).

In an embodiment, device one 320 includes user interface 324. A user interface is a program that provides an interface between a user and an application. A user interface refers to the information (such as graphic, text, and sound) a program presents to a user and the control sequences the user employs to control the program. There are many types of user interfaces. In one embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements. For example, client application may be a web browser, a database program, etc. In an embodiment, user interface 324 may be substantially similar to user interface 334.

In an embodiment, device one 320 includes application 322. In an embodiment, application 322 is a program or add-on to another program that a user may want to print information from (e.g., word processor, photo editor, electronic mail client, etc.). In an embodiment, application 322 may provide a feature allowing users to print content stored or displayed from the application. In an embodiment, application 322 may be a program designed to perform a specific function or tasks provided by a user or other applications. For example, application 322 may be a word processor that a user uses to edit, modify, or create a document in and then eventually the user may print the document from the word processor. In another example, application 322 may be a photo editor that a user uses to edit, modify, or create a picture and then eventually user may print the picture from the photo editor.

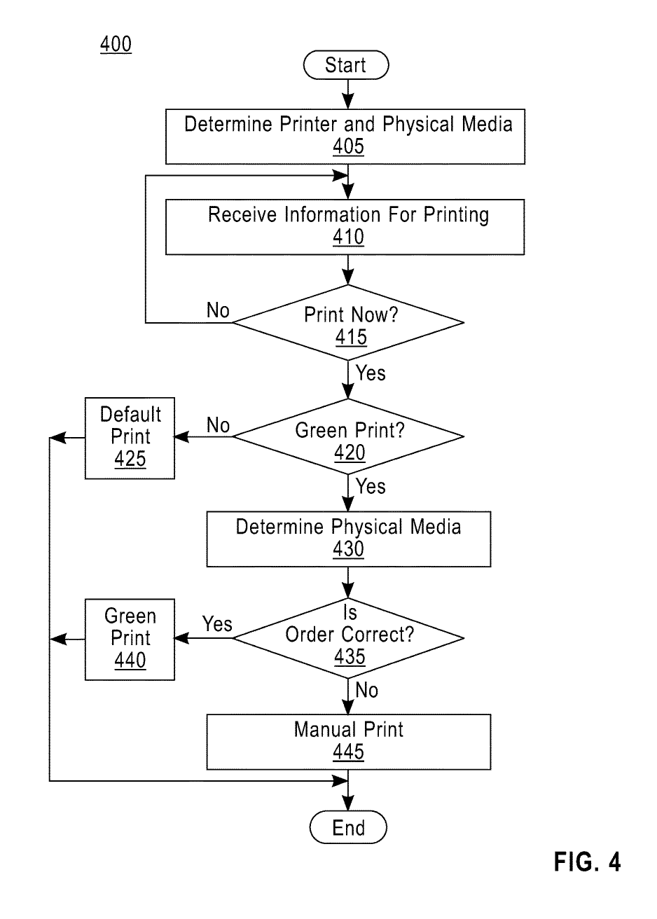

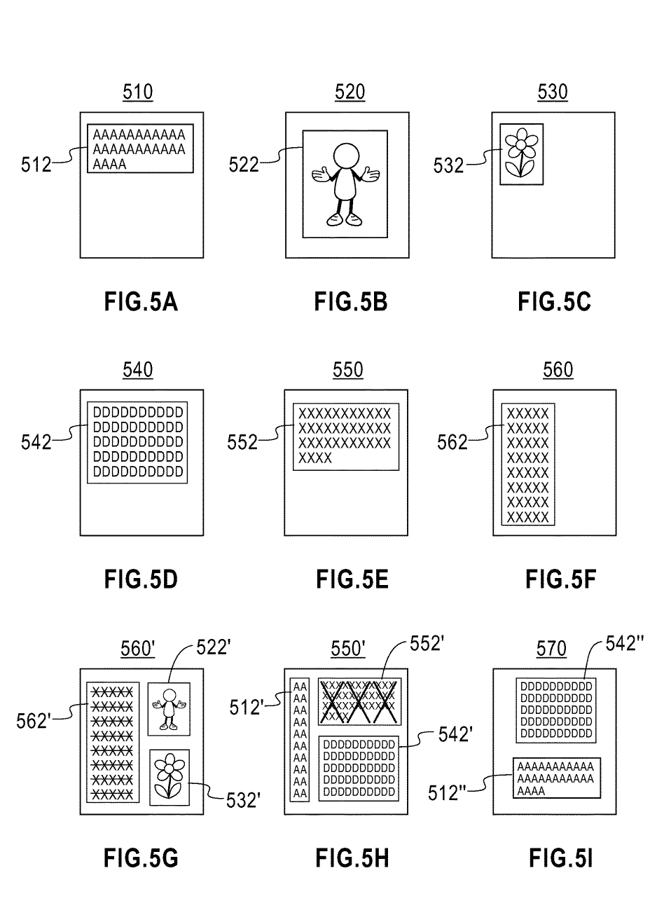

FIG. 4 is a flowchart of workflow 400 depicting operational steps for managing printing to reduce physical media waste, in accordance with an embodiment of the present invention. Workflow 400 represents the operational steps to perform printing optimization 96 in workloads layer 90. In one embodiment, the steps of the workflow are performed by printing program 312. In an alternative embodiment, steps of the workflow can be performed by any other program while working with printing program 312. In a preferred embodiment, a user, via a user interface discussed previously, can invoke workflow 400 upon determining that the user would like to print information. Workflow 400 will be discussed in reference to FIGS. 5A-5I, which depict example embodiments of information to be printed (FIGS. 5A-5D), example embodiments of information already printed on physical media (FIGS. 5E and 5F), and example embodiments of managing printing of information on physical media (FIGS. 5G-5I).

Printing program 312 determines a printer and physical media (step 405). In an embodiment, printing program 312 may receive an indication from a user regarding a printing device or printing devices that the user wants to use when printing. For example, a user may indicate, via user interface 324, that the user would like to use printing/scanning device 310 for all printing jobs. In an alternative embodiment, printing program 312 may receive the indication from a program or operating system of a device that all printing jobs from that device are associated with a printer. For example, the operating system of device one 320 may indicate that all jobs printed from device one 320 will use printing/scanning device 310 for all printing jobs. In an embodiment, when determining the printer, printing program 312 may also determines a printing buffer, found in printing repository 314, to associate with the user. In an alternative embodiment, when determining the printer, printing program 312 may also determine a printing buffer, found in printing repository 314, to associate with a group of users. In an embodiment, printing program 312 may determine the physical media that can be printed to. In other words, printing program 312 receives an indication from a user, a program of printing/scanning device 310 (not shown), or a program of device one 320, as to the types of physical media that printing/scanning device 310 may print to. For example, printing program 312 may receive an indication that printing/scanning device 310 has three trays (i.e., physical media storage locations) and the first tray holds white blank unused paper, the second tray hold colored blank unused paper, and the third tray holds white previously used paper (i.e. the paper has been printed on previously).

Printing program 312 receives information for printing (step 410). In other words, printing program 112 receives information indicated by a user to be printed on the determined printer. In an embodiment, printing program 312 may receive information indicated by a user to be printed from application 322 found on device one 320. In an alternative embodiment, printing program 312 may receive information indicated by a user to be printed from multiple applications found on device one 320. In yet another alternative embodiment, printing program 312 may receive information indicated by a user to be printed from application 322 found on device one 320 and from application 332 found on device two 330. For example, a user may be using a word processing program on a personal computer and may send a text document to be printed on a printer. In this example, the text of the word document is text 512 of document 510 found in FIG. 5A or is text 542 of document 540 found in FIG. 5D. Continuing that example, the same user may be using a web browsing program on a cellular device and may send a picture to be printed on the printer. In this continuing example, the picture is picture 522 of document 520 found in FIG. 5B or is picture 532 of document 530 found in FIG. 5C. It should be noted that document 510, 520, 530, and 540 are not documents that have already been printed but are representative of areas on a screen to be printed (e.g., the screen area of a word processor program or screen area of a web browser).

Printing program 312 determines whether there has been an indication to print now (decision block 415). In an embodiment, the indication may be to print some or all of the information in a printing buffer associated with a user that indicates to print. If there is a determination that there was not an indication to print (decision block 415, no branch), then printing program 312 continues to receive information for printing (step 410). If there is a determination that there is an indication to print (decision block 415, yes branch), then printing program 312 determines whether there has been an indication to green print (decision block 420).

Printing program 312 determines whether there has been an indication to green print (decision block 420). In an embodiment, the indication may be included together with or in the same indication that is received in decision block 415, discussed previously. In an alternative embodiment, the indication may be a separate indication to green print some or all of the information in a printing buffer associated with a user that indicates to print. If there is a determination that there is not an indication to green print (decision block 420, no branch), printing program 312 will print the information received for printing in a default print order (step 425). In an embodiment, the default printer order may be printing the information received for printing in the order the information was received. In other words, the first item of information in the printing buffer is printed first, the second item of information in the printing buffer is printed second, etc. In an embodiment, each item of information to be printed is printed on a new sheet. In an alternative embodiment, each item of information is continually printed on sheets of paper (i.e., a piece of physical media may have more than one item of information on the physical media). In an embodiment, if the indication is to print any of the information on physical media that already has information printed on the physical media, printing program 312, using printing/scanning device 310, may scan the physical media that already has information printed on the physical media to determine available space to print separate information on. In an alternative embodiment, if the indication is to print any of the information on physical media that already has information printed on the physical media, printing program 312 may receive information about the physical media with printed information already on the physical media from another program or device (not shown). For example, as shown in FIG. 5E, paper 550 already has printed information 552. In another example, as shown in FIG. 5F, paper 560 already has printed information 562.

Printing program 312 determines the physical media (step 430). In other words, printing program 312 determines the physical media that the information for printing will be printed on. In an embodiment, printing program 312 receives an indication from the user that indicates whether the information to be printed should be printed on blank, unused physical media, physical media with information already printed on portions of the physical media, or a combination of both. In an embodiment, this indication may be included together with or in the same indication that was received in decision block 415 or decision block 420. In an alternative embodiment, this may be a separate indication. In an embodiment, if printing program 312 receives an indication that some or all of the information to be printed should be printed on physical media with information already printed on portions of the physical media, printing/scanning device 310 scans the physical media with information already printed on portions of the physical media. For example, as shown in FIG. 5E, a printing/scanning device 310 scans paper 550 and determines the printed information 552 is information already printed on paper 550. In another example, as shown in FIG. 5F, a printing/scanning device 310 scans paper 560 and determines the printed information 562 is information already printed on paper 560.

Printing program 312 determines whether the order is correct (decision block 435). In other words, printing program 312 determines an order that the information to be printed will be printed on the physical media and then receives an indication from the user as to whether this order is correct. In another embodiment, printing program 312 may arrange the items to be printed to minimize the usage of space or area on the determined physical media. In an embodiment, printing program 312 determines an order to place the information to be printed on the previously determined physical media. In an embodiment, printing program 312 determines an order that will use as little or few pieces of physical media as possible. In an embodiment, printing program 312 may modify the size of the information to be printed (e.g., modify the size of pictures or modify the size of text) so as to create an order of the information to be printed that uses less physical media. In an embodiment, information to be printed may be printed in any blank or “white space” of physical media (e.g., the margins of physical media). In an embodiment, area that has previously been printed may be indicated by the information being crossed out.

For example, as shown in FIG. 5G, paper 560′, which is paper 560 with the information to be printed, includes printed information 562′ of already printed information that has lines through printed information 562′ along with picture 522′, which is picture 522 discussed previously, and picture 532′ which is picture 532 discussed previously, and picture 522′ and 532′ have been resized to fit on paper 560′. In another example, as shown in FIG. 5H, paper 550′, which is paper 550 with the information to be printed, includes printed information 552′ of already printed information has “X” marks through printed information 552′ along with text 542′, which is text 542 discussed previously, and text 512′, which is text 512 discuss previously, that has been resized and placed in the margins. In yet another example, as shown in FIG. 5I, paper 570 is a blank piece of physical media with no information printed on paper 570 previously, that includes text 542′ which is text 542 discussed previously, and also includes text 512″ which is text 512′ discuss previously.

The determined order is displayed to the user via a user interface (i.e., user interface 324, 334) on the device that the user used to indicate to print. The user reviews the displayed order, and responsive to determining the order is correct (decision block 435, yes branch), printing program 312 green prints (step 440) in the determined order. In other words, printing program 312 indicates to printing/scanning device 310 to print the information in the determined order.

If the user reviews the displayed order and determines the order is not correct (decision block 435, no branch), printing program 312 receives an indication from the user, via a user interface (i.e., user interface 324, 334), of a new order that the information should be printed and printing program 312 manual prints (step 445) in the newly indicated order. In an embodiment, the new order may be a completely new order or a revised order of the previously sent order created by printing program 312. In other words, the user, via the user interface, can modify, edit, change, or in any other way manipulate the location, size, shape, etc., of any of the information to be printed on the physical media.

FIG. 6 depicts computer system 600, that is an example of a system that includes printing program 312. Computer system 600 includes processors 601, cache 603, memory 602, persistent storage 605, communications unit 607, input/output (I/O) interface(s) 606 and communications fabric 604. Communications fabric 604 provides communications between cache 603, memory 602, persistent storage 605, communications unit 607, and input/output (I/O) interface(s) 606. Communications fabric 604 can be implemented with any architecture designed for passing data and/or control information between processors (such as microprocessors, communications and network processors, etc.), system memory, peripheral devices, and any other hardware components within a system. For example, communications fabric 604 can be implemented with one or more buses or a crossbar switch.

Memory 602 and persistent storage 605 are computer readable storage media. In this embodiment, memory 602 includes random access memory (RAM). In general, memory 602 can include any suitable volatile or non-volatile computer readable storage media. Cache 603 is a fast memory that enhances the performance of processors 601 by holding recently accessed data, and data near recently accessed data, from memory 602.

Program instructions and data used to practice embodiments of the present invention may be stored in persistent storage 605 and in memory 602 for execution by one or more of the respective processors 601 via cache 603. In an embodiment, persistent storage 605 includes a magnetic hard disk drive. Alternatively, or in addition to a magnetic hard disk drive, persistent storage 605 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 605 may also be removable. For example, a removable hard drive may be used for persistent storage 605. Other examples include optical and magnetic disks, thumb drives, and smart cards that are inserted into a drive for transfer onto another computer readable storage medium that is also part of persistent storage 605.

Communications unit 607, in these examples, provides for communications with other data processing systems or devices. In these examples, communications unit 607 includes one or more network interface cards. Communications unit 607 may provide communications through the use of either or both physical and wireless communications links. Program instructions and data used to practice embodiments of the present invention may be downloaded to persistent storage 605 through communications unit 607.

I/O interface(s) 606 allows for input and output of data with other devices that may be connected to each computer system. For example, I/O interface 606 may provide a connection to external devices 608 such as a keyboard, keypad, a touch screen, and/or some other suitable input device. External devices 608 can also include portable computer readable storage media such as, for example, thumb drives, portable optical or magnetic disks, and memory cards. Software and data used to practice embodiments of the present invention can be stored on such portable computer readable storage media and can be loaded onto persistent storage 605 via I/O interface(s) 606. I/O interface(s) 606 also connect to display 609.

Display 609 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method for managing printing to reduce physical media waste, the method comprising the steps of:
determining, by one or more computer processors, one or more information for printing associated with one or more users;
determining, by one or more computer processors, one or more printers having one or more physical media associated with the one or more printers, wherein the one or more of the physical media has persistent human readable representations of graphics or text on the physical media before printing;
receiving, by one or more computer processors, a first indication from a user of the one or more users to print the one or more information associated with the user;
scanning, by one or more computer processors, the one or more physical media using the one or more printers;
determining, by one or more computer processors, available printing space on the one or more physical media based on the scanning of the one or more physical media;
determining, by one or more computer processors, an order of the one or more information to be printed on the one or more physical media, wherein the order minimizes the usage of the available printing space on the one or more physical media;
determining, by one or more computer processors, whether a second indication was received from the user that the order is correct; and
responsive to determining a second indication was received, printing, by the one or more computer processors, the one or more information on the one or more physical media in the order on the one or more printers.

2. (canceled)

3. The method of claim 1, further comprising:
receiving, by one or more computer processors, a revised order from the user; and
responsive to receiving the revised order, printing, by one or more computer processors, the one or more information on the one or more physical media in the revised order.

4. The method of claim 1, wherein the one or more information for printing is stored on one printer of the one or more printers.

5. The method of claim 1, wherein the physical media is one or more of the following: paper, recycled paper, plastic, carbon paper, or transparencies.

6. (canceled)

7. The method of claim 1, wherein the physical media is one or more of the following:
polymide, ABS (Acylonitrile Butadiene Styrene), PLA (Poly Lactic Acid), or wax.

8. A computer program product for printing to reduce physical media waste, the computer program product comprising:
one or more computer readable storage medium; and
program instructions stored on the one or more computer readable storage medium, the program instructions comprising:
program instructions to determine one or more information for printing associated with one or more users;
program instructions to determine one or more printers having one or more physical media associated with the one or more printers, wherein the one or more of the physical media has persistent human readable representations of graphics or text on the physical media before printing;
program instructions to receive a first indication from a user of the one or more users to print the one or more information associated with the user;
program instructions to scan the one or more physical media using the one or more printers;
program instructions to determine available printing space on the one or more physical media based on the scanning of the one or more physical media;
program instructions to determine an order of the one or more information to be printed on the one or more physical media, wherein the order minimizes the usage of the available printing space on the one or more physical media;
program instructions to determine whether a second indication was received from the user that the order is correct; and
program instructions, responsive to determining a second indication was received, to print the one or more information on the one or more physical media in the order on the one or more printers.

9. (canceled)

10. The computer program product of claim 8, further comprising program instructions, stored on the one or more computer readable storage medium media, to:
receive a revised order form the user; and
responsive to receiving the revised order, print the one or more information on the one or more physical media in the revised order.

11. The computer program product of claim 8, wherein the one or more information for printing is stored on one printer of the one or more printers.

12. The computer program product of claim 8, wherein the physical media is one or more of the following: paper, recycled paper, plastic, carbon paper, or transparencies.

13. (canceled)

14. The computer program product of claim 8, wherein the physical media is one or more of the following:
polymide, ABS (Acylonitrile Butadiene Styrene), PLA (Poly Lactic Acid), or wax.

15. A computer system for printing to reduce physical media waste, the computer system comprising:
one or more computer processors;
one or more computer readable storage media; and
program instructions stored on the one or more computer readable storage media for execution by at least one of the one or more computer processors, the program instructions comprising:
program instructions to determine one or more information for printing associated with one or more users;
program instructions to determine one or more printers having one or more physical media associated with the one or more printers, wherein the one or more of the physical media has persistent human readable representations of graphics or text on the physical media before printing;
program instructions to receive a first indication from a user of the one or more users to print the one or more information associated with the user;
program instructions to scan the one or more physical media using the one or more printers;
program instructions to determine available printing space on the one or more physical media based on the scanning of the one or more physical media;
program instructions to determine an order of the one or more information to be printed on the one or more physical media, wherein the order minimizes the usage of the available printing space on the one or more physical media;
program instructions to determine whether a second indication was received from the user that the order is correct; and
program instructions, responsive to determining a second indication was received, to print the one or more information on the one or more physical media in the order on the one or more printers.

16. (canceled)

17. The computer system of claim 15, further comprising program instructions, stored on the one or more computer readable storage media for execution by the at least one of the one or more computer processors, to:
receive a revised order form the user; and
responsive to receiving the revised order, print the one or more information on the one or more physical media in the revised order.

18. The computer system of claim 15, wherein the one or more information for printing is stored on one printer of the one or more printers.

19. The computer system of claim 15, wherein the physical media is one or more of the following: paper, recycled paper, plastic, carbon paper, or transparencies.

20. (canceled)

21. The computer system of claim 15, wherein the physical media is one or more of the following:
polymide, ABS (Acylonitrile Butadiene Styrene), PLA (Poly Lactic Acid), or wax.
